(19) United States
(12) Patent Application Publication
(10) Pub. No.: US 2010/0157022 A1
(43) Pub. Date: Jun. 24, 2010

(54) METHOD AND APPARATUS FOR IMPLEMENTING MOTION CONTROL CAMERA EFFECT BASED ON SYNCHRONIZED MULTI-IMAGES

(75) Inventors: Yoon-Seok Choi, Daejeon (KR); Jeung Chul Park, Daejeon (KR); Chang Woo Chu, Daejeon (KR); Ji Hyung Lee, Daejeon (KR); Bon Ki Koo, Daejeon (KR); Jin Seo Kim, Daejeon (KR); Seung Woook Lee, Daejeon (KR); Ho Won Kim, Daejeon (KR); Bon Woo Hwang, Daejeon (KR); Young Jik Lee, Daejeon (KR)

Correspondence Address: STAAS & HALSEY LLP, SUITE 700, 1201 NEW YORK AVENUE, N.W., WASHINGTON, DC, 20005, US

(73) Assignee: Electronics and Telecommunications Research Institute, Daejeon (KR)

(21) Appl. No.: 12/495,169

(22) Filed: Jun. 30, 2009

(30) Foreign Application Priority Data
Dec. 22, 2008 (KR) 10-2008-0131665

(51) Int. Cl. H04N 13/02

(52) U.S. Cl. 348/48; 348/E13.074; 348/222.1

(57) ABSTRACT

A method of implementing a motion control camera effect includes: inputting images of an object captured at one or more points of view; inputting a control parameter containing a motion control camera effect to be applied to the input images, a target time of the motion control camera effect, and a reproducing speed; extracting frames of the target time from the input images; processing the frames using software based on the control parameter; and outputting the processed frames at the reproducing speed. The motion control camera effect includes at least one of a motion control camera effect for a fixed viewpoint still object, a motion control camera effect for a fixed viewpoint moving object, a motion control camera effect for a free viewpoint still object, a motion control camera effect for a free viewpoint moving object, and a dual motion control camera effect.

### CROSS-REFERENCE(S) TO RELATED APPLICATION(S)

The present invention claims priority of Korean Patent Application No. 10-2008-0131665, filed on Dec. 22, 2008, which is incorporated herein by reference.

### FIELD OF THE INVENTION

The present invention relates to method and apparatus for implementing a multi-image based motion control camera effect; and, more particularly, to a real time multiple image managing method and apparatus for implementing 360-degree turning image of a motion control camera (MCC) based on several high-definition (HD) images.

### BACKGROUND OF THE INVENTION

As image processing technology is developed, existing 2D multimedia services are evolving into real picture-based 3D actual feeling services. In particular, broadcasting technology, in order to broadcast life-like scene of an actual spot, is explosively being developed based on various camera technologies. Due to recent trends of communications-broadcasting convergence, research and development for communications-broadcasting full 3D restoring technology is also being carried out.

There are several existing camera technologies such as a slow motion camera capturing detailed movement of an object, a rail camera following on rails an object that quickly moves through space, and a crane camera, mounted to an end of an arm of a crane, capturing the movement of an object effectively in various view angles. Image engineers at broadcasting stations film dynamic and vivid images with these technologies. However, it is getting hard for only a hardware camera such as an ultra-high speed camera, the slow motion camera, the rail camera, the crane camera, and the like, to satisfy various viewers' demands.

Sport broadcasting among various broadcasting contents particularly requires more various technologies in order to provide vivid movements of players who play in a stadium. When plural cameras are installed in several directions to capture a sports game so that synchronized multiple images are obtained and selectively combined with each other, viewers can be provided with images as if they move along stands in the stadium here and there to take the best seats to watch an instant highlight scene.

In the existing technology, in order to implement a 360-degree turning image or a still image of an object stopped in mid-air, an image is acquired using an image collecting device utilizing a motion control camera or several still cameras and a desired effect is applied to the acquired image by controlling a device such as a switch. To this processing, many devices such as a digital control unit (DCU), a master setup unit (MSU), a digital multiplex equipment (DME), a digital video switcher, a digital video tape recorder, and the like are needed. However, these devices are very expensive and have restriction for installation and transfer, and the cameras and the control equipment have restricted functions, implemented by hardware, such as only color transform, caption insertion, and the like.

Therefore, there are continuous approaches for combining technologies acquiring synchronizing multiple images with computer-based image processing technologies to easily control cameras and to provide an image with various effects.

### SUMMARY OF THE INVENTION

It is, therefore, a primary object of the present invention to provide a method of implementing an effect of a multiple HD image-based motion control camera for producing a 360-degree turning image of an object as if an image is produced using the motion control camera.

It is another object of the present invention to provide a method of implementing an integrated motion control camera effect for various object such as a fixed viewpoint still object, a fixed viewpoint moving object, a free viewpoint still object, and a free viewpoint moving object.

It is still another object of the present invention to provide a motion control camera effect implementing apparatus for taking a software approach to viewers' various demands of broadcast images so that equipment costs can be reduced.

In accordance with one aspect of a method of implementing a motion control camera effect including: inputting images of an object captured at one or more points of view; inputting a control parameter containing a motion control camera effect to be applied to the input images, a target time of the motion control camera effect, and a reproducing speed; extracting frames of the target time from the input images; processing the frames using software based on the control parameter; and outputting the processed frames at the reproducing speed.

The motion control camera effect may include at least one of a motion control camera effect for a fixed viewpoint still object, a motion control camera effect for a fixed viewpoint moving object, a motion control camera effect for a free viewpoint still object, a motion control camera effect for a free viewpoint moving object, and a dual motion control camera effect, in accordance with whether a point of view is fixed or free and the object is stopped or moving.

In a case of the motion control camera effect for the fixed viewpoint still object, in the processing the frames using the software based on the control parameter, the extracted frames may be arranged in accordance with the control parameter.

In a case where of the motion control camera effect for the fixed viewpoint moving object, the target time may have a starting time and an ending time of a movement of the object; and in the processing the frames using the software based on the control parameter, the extracted frames may be arranged in accordance with the control parameter.

In a case of the motion control camera effect for the free viewpoint still object, the processing the frames using software based on the control parameter, includes: extracting corresponding points between adjacent frames; calculating camera geometric information based on the corresponding points; and producing an interpolation image between the adjacent frames.

In the calculating camera geometric information, fundamental matrices are obtained based on the corresponding points; and wherein, in the producing the interpolation image between the adjacent frames, the extracted images are rectified using the fundamental matrices and the interpolation image is produced by applying a morphing-based method to the rectified images.

In a case of the motion control camera effect for the free viewpoint moving object, the extracting the frames of the target time from the input images includes: producing basis frames by applying frame skip to the input images from the starting time to the ending time of the movement of the object; and combining the frames into pairs at the same time from the starting time to the ending time into the input images and applying frame skip to produce an interpolation reference frame, in the processing the frames using the software based on the control parameter, the extracted images are rectified based on the interpolation reference frame and interpolation image between the adjacent frames.

In the processing the frames using the software based on the control parameter, the interpolation image may be produced using the interpolation reference frame and a frame set of the interpolation reference frame.

In the producing the interpolation image between the adjacent frames, the extracted images may be rectified using the frame pairs at the same time and a morphing-based method is applied to the rectified images to produce the interpolation images.

The producing the interpolation image by applying the morphing-based method to the rectified images may be processed using a high speed image processing device based on hardware acceleration in real time.

In a case of the dual motion control camera effect, the input of the images of the object captured at said one or more points of view may include: inputting two images of the object captured at various view points independently; and determining a first image from which a foreground is extracted and a second image from which a foreground and a background are extracted from the two images of the object, and the extracting the frames at the target time from the input images is performed to the first image and the second image at the same time; and the processing the frames using the software based on the control parameter includes:

extracting the foreground from a frame of the first image; extracting the foreground and the background from the second image; combining the foreground of the first image with the foreground and the background of the second image to combine frames of the first image with frames of the second images; and arranging the combined frames in accordance with the control parameter.

In the determination the first image from which the foreground may be extracted and the second image from which the foreground and the background are extracted from the two images of the object, the determining is made by an input from a user.

In the combining the foreground of the first image with the foreground and the background of the second image, brightness, color, and a light source of the foreground of the first image may be compared with those of the foreground and the background of the second image to be calibrated.

In the combining the foreground of the first image with the foreground and the background of the second image, moving speeds of the foreground of the first image and the foreground of the second image are independently controlled by making frame arranging speeds of the foreground of the first image and the foreground of the second image different from each other.

The control parameter may include a reproducing direction.

In accordance with another aspect of the invention, an apparatus for implementing a motion control camera effect, includes: an image acquiring unit for receiving images of an object captured at one or more points of view; a motion control camera effect input unit for receiving a motion control camera effect to be applied; a control parameter input unit for receiving a control parameter including a target time and a reproducing speed of the motion control camera effect; and a motion control camera effect processing unit for performing at least one of processing a motion control camera effect for a still object and a moving object at a fixed viewpoint and a free viewpoint and a dual motion control camera effect of receiving at least one image and combining a foreground of at least one image with a foreground and a background of another image.

The motion control camera effect processing unit may include: at least one of fixed viewpoint still object motion control camera effect processors for implementing the motion control camera effect for the still object at the fixed viewpoint, a fixed viewpoint moving object motion control camera effect processor for implementing the motion control camera effect for the moving object at the fixed viewpoint, a free viewpoint still object motion control camera effect processor for implementing the motion control camera effect for the still object at the free viewpoint, a free viewpoint moving object motion control camera effect processor for implementing the motion control camera effect for the moving object at the free viewpoint, and a dual motion control camera effect processor for receiving at least one input image and combining the received images such that a foreground of one of the input images is combined with a foreground and a background of another received image; a frame extractor for extracting frames at the target time from the input images; a frame processor for processing the frames based on the control parameter; and a frame output unit for selecting and outputting the processed frames in accordance with the reproducing speed.

The frame processor of the free viewpoint still object motion control camera effect processor may include: a corresponding point extractor for extracting a corresponding point between adjacent frames; a camera geometric information calculator for calculating camera geometric information based on the corresponding point; and an interpolation image producer for producing an interpolation image between the adjacent frames.

The camera geometric information estimator comprises a fundamental matrix calculator obtaining a fundamental matrix based on the corresponding point; and wherein the interpolation image producer has: a rectifier for rectifying the input images using the fundamental matrix; and a morphing unit for producing the interpolation image.

The frame extractor of the free viewpoint moving object motion control camera effect processor includes: a basis frame producer for producing a basis frame by applying frame skip to the input image from a starting time to an ending time of the moving object of the input image; an interpolation reference frame producer for producing interpolation reference frames by combining frames at the same time into frame pairs and by applying the frame skip to the input image from the starting time to the ending time; an interpolation reference frame-based rectifier for rectifying the input image based on the interpolation reference frame; and an interpolation image producer for producing an interpolation image between the adjacent frames.

The frame processor of the free viewpoint moving object motion control camera effect processor produces the interpolation image by using the basis frame and a frame set of the interpolation reference frames.

The interpolation image producer may include: a frame pair using rectifier for rectifying the input images by using the frame pairs at the same time; and a morphing unit for producing the interpolation image by applying a morphing-based method to the rectified images.

The apparatus may further comprise a high speed image processing device for supporting a real time processing of the morphing unit through hardware acceleration.

The image acquiring unit may receive two images of the object captured at one or more points of view and comprises an image determining unit for determining a first image from which a foreground is extracted and a second image from which a foreground and a background are extracted from the two images, based on an input from a user; the frame extractor of the dual motion control camera effect processor performs the extractions from the first and second images simultaneously; and the frame processor of the dual motion control camera effect processor includes: a first image foreground extractor extracting the foreground from a frame of the first image; a second image foreground-background extractor extracting the foreground and the background from a frame of the second image; a foreground-background combining unit combining the foreground of the first image with the foreground and the background of the second image; and a frame arranger arranging the combined frames in accordance with the control parameter.

In accordance with the present invention, a 3D 360-degree image of a object can be implemented as if the image is actually produced by a motion control camera.

Moreover, various functions such as motion control camera effects of a fixed viewpoint still object, a fixed viewpoint moving object, a free viewpoint still object, and a free viewpoint moving object are processed with software so that the system for processing an image can be simplified and easy upgrade is convenient.

Further, restrictions such as expensive equipment and working space are overcome so that installation becomes easy and the method and apparatus of the present invention can be applied to a huge space such as an athletic track, a football stadium, and the like.

Furthermore, since the motion control camera effect implementing function of the present invention is supported with software, various motion effects can be produced and a 3D TV image can be expanded to a stereo image.

### BRIEF DESCRIPTION OF THE DRAWINGS

The above and other objects and features of the present invention will become apparent from the following description of embodiments, given in conjunction with the accompanying drawing, in which:

FIG. 1 is a flowchart schematically illustrating a method of implementing a motion control camera effect in accordance with an embodiment of the present invention;

FIG. 2 is a flowchart illustrating steps of a method of implementing a motion control camera effect for a fixed viewpoint still object in accordance with an embodiment of the present invention;

FIG. 3 is a flowchart illustrating steps of a method of implementing a motion control camera effect for a fixed viewpoint moving object in accordance with an embodiment of the present invention;

FIG. 4 is a flowchart illustrating a method of implementing a motion control camera effect for a free viewpoint still object in accordance with an embodiment of the present invention;

FIG. 5 is a flowchart illustrating a method of implementing a motion control camera effect for a free viewpoint moving object in accordance with an embodiment of the present invention;

FIG. 6 is a flowchart illustrating a method of implementing a dual camera effect in accordance with an embodiment of the present invention; and

FIG. 7 is a schematic block diagram illustrating an apparatus for implementing a motion control camera effect in accordance with an embodiment of the present invention.

### DETAILED DESCRIPTION OF THE EMBODIMENTS

Hereinafter, embodiments of the present invention will be described in detail with reference to the accompanying drawings. Detailed descriptions of well-known functions and structures incorporated herein may be omitted to avoid obscuring the subject matter of the present invention. Particular terms may be defined to describe the invention in the best manner. Accordingly, the meaning of specific terms or words used in the specification and the claims should not be limited to the literal or commonly employed sense, but should be construed in accordance with the scope of the invention.

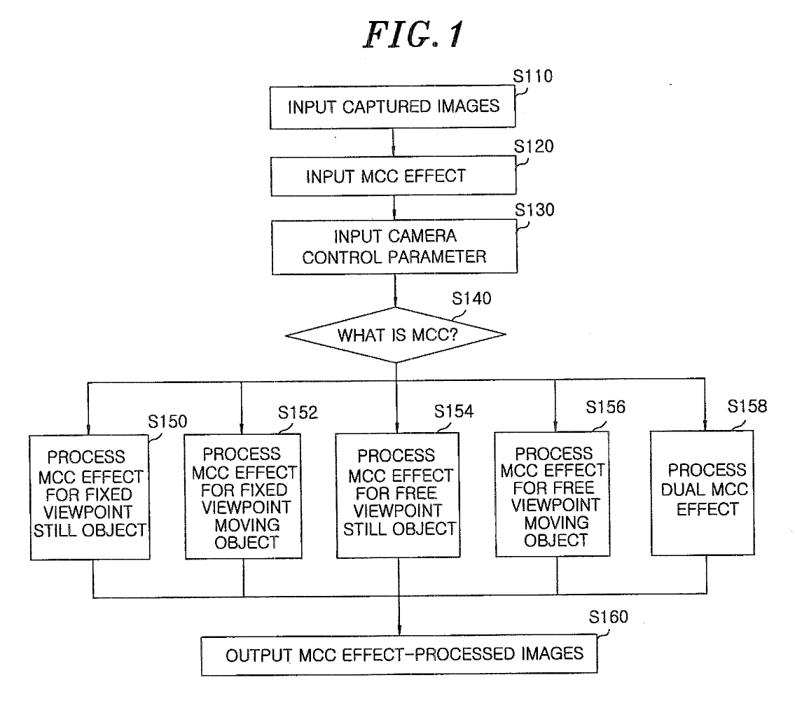

FIG. 1 is a flowchart schematically illustrating a method of implementing a motion control camera effect in accordance with an embodiment of the present invention.

First, images of an object captured at one or more points of view are inputted (S110). The images of the object may be acquired by a system including multiple HD cameras, control equipment thereof, and storage. After that, a motion control camera effect to be applied is inputted (S120), and a control parameter including a target time and reproducing speed of the motion control camera effect is inputted (S130). The control parameter may further include additional information from viewpoint and operation of a camera of implementing a motion control camera effect such as information on a reproducing direction of the motion control camera effect.

Based on the motion control camera effect inputted by a user (S140), at least one of a motion control camera effect of a fixed viewpoint still object (S150), a fixed viewpoint moving object (S152), a free viewpoint still object (S154), a free viewpoint moving object (S156), and a dual motion control camera effect (S158) is performed.

A fixed viewpoint motion control effect means implementation of sequentially reproducing only images actually acquired by a camera to implement the motion control camera effect, and a free viewpoint motion control camera effect means implementation of reproducing not only images acquired by an actually installed camera but an image interpolated at any point of view. A still object motion control camera effect means a motion control camera effect when an object is stopped and a point of view only moves, and a moving object motion control camera effect means a motion control camera effect when both of an object and a point of view move.

Each of the motion control camera effects (S150, S152, S154, S156, and S158) includes a procedure of extracting frames of a target time from the inputted images, of processing the frames using software based on the control parameter, and of outputting the processed frames selectively at a reproducing speed. Here, the procedure of processing the frames using the software based on the control parameter is varied in accordance with whether a point of view is fixed and an object is stopped. Hereinafter, the procedure will be described in detail.

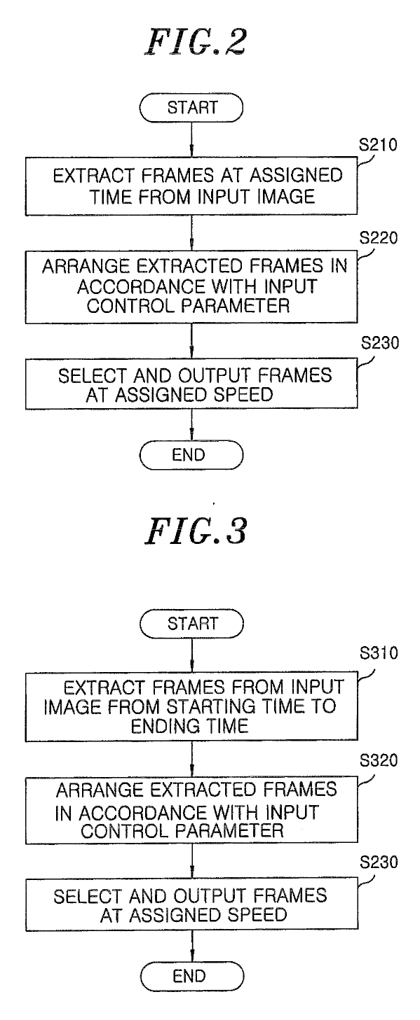

FIG. 2 is a flowchart illustrating steps of a method of implementing a motion control camera effect for a fixed viewpoint still object in accordance with an embodiment of the present invention.

The motion control camera effect technique of a fixed viewpoint still object presents natural motion control camera effect when the number of cameras increases, but has disadvantages of requiring a great deal of data, of having a difficulty to control the cameras, and of being complicated.

First, in the method of implementing a motion control camera effect for a fixed viewpoint still object, frames of a target time are extracted from the inputted images (S210). The frames frame_{i,t} are extracted from the images acquired by n cameras at the assigned target time. Here, i (1≦i≦n) is a camera that acquires the image from which the frame is extracted and t is a target time. In a case of the motion control camera effect of a fixed viewpoint still object, t has a value corresponding to a specific time.

After that, the extracted frames are arranged in accordance with the control parameter using software (S220) and the processed frames are selectively outputted at an inputted reproducing speed (S230). In this case, the object in the images is at a stopping state because only images at a specific time t are utilized. The following F_{static} defines a frame set required to express the still object motion control camera effect. In the frame set, frames adjacent to each other constitute adjacent frames.

F_{static}={frame_{1,t}, frame_{2,t}, frame_{3,t}, . . . , frame_{i,t}, frame_{n-1,t}, frame_{n,t}}

FIG. 3 is a flowchart illustrating steps of a method of implementing a motion control camera effect for a fixed viewpoint moving object.

In a case of a moving object, since information on a starting time s and an ending time s+k of the movement of the object are required, frames from the starting time to the ending time are extracted from the input images (S310). The frames frame_{i,s+j} are extracted from the images acquired by the n cameras from the starting time s to proceeding of time j. Here, i (1≦i≦n) is a camera of acquiring an image from which one of the frames is extracted and j (1≦j≦k) is a lapse of time.

After that, the extracted frames are arranged in accordance with the control parameter using software (S220) and the processed frames are selectively outputted in accordance with the inputted reproducing speed (S230). Then, in this case, the object moves along with the lapse of time j. The following F_{active} means a frame set used in the moving object motion control camera effect. Even in this case, frames adjacent to each other constitute adjacent frames.

$${F}_{active} = \{ \begin{matrix}{frame}_{1 , s + 1} , {frame}_{2 , s + 2} , {frame}_{3 , s + 3} , … , {frame}_{i , s + j} , … , \\ {frame}_{n - 1 , k - 1} , {frame}_{n , k}\end{matrix} \}$$

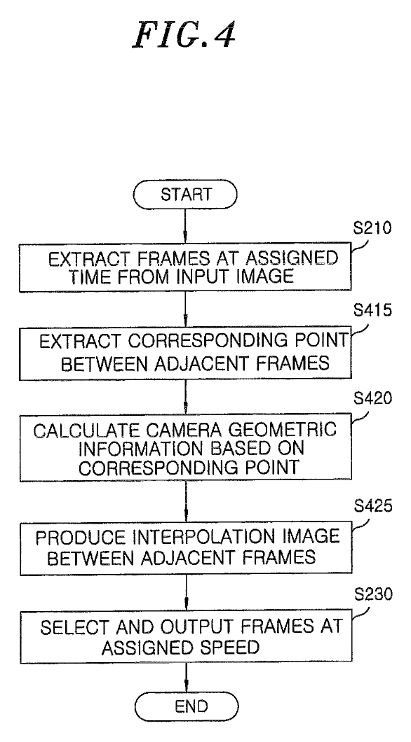

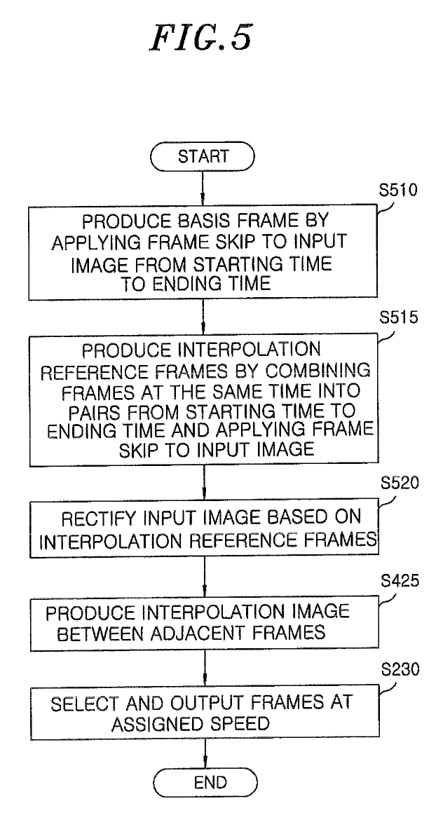

FIG. 4 is a flowchart illustrating a method of implementing a motion control camera effect for a free viewpoint still object.

First, frames at a target time are extracted from the input images (S210). Here, the frames at the target time, which are extracted from the images acquired by the respective cameras, becoming a reference may be set as basis frames.

After that, corresponding points between the adjacent frames are extracted (S415), camera geometric information is calculated based on the corresponding points (S420), and interpolated images between the adjacent frames are produced (S425). In order to perform this procedure, the number of free viewpoint image frames to be produced between the images at fixed points of view, a corresponding point extraction technique for producing a free viewpoint image, and a basis function generating method must be set. The image interpolation may be performed in the extracted basis frames based on the adjacent frames. The images are analyzed to analyze geometric positions of the multiple cameras and the corresponding points between the adjacent images are extracted such that the interpolation image is set based on a linear or non-linear interpolation function by using the analyzed geometric positions and the extracted corresponding points. In every embodiment, fundamental matrices are obtained based on the corresponding points, and the extracted images are rectified using the fundamental matrices, such that techniques of producing the interpolation images by using a morphing-based method may be applied to the rectified images.

The frames processed in accordance with the input reproducing speed are outputted (S230).

FIG. 5 is a flowchart illustrating a method of implementing a motion control camera effect for a free viewpoint moving object.

In the motion control camera effect of a free viewpoint moving object, unlike the case of the still object, since feature points corresponding to the images are varied not only by the geometries of the cameras but the movements of an object, the calculation of fundamental matrices through the corresponding point extraction cannot be performed. Thus, in this embodiment, a frame skip technique is utilized. The frame skip technique is used to skip frames one by one and to select a frame at next-next time (s+3, s+5, . . . ) without selection of a frame of time s+2 which is directly next to a specific time s+1.

In a case of the moving object, since information on a starting time and an ending time of the movement of the moving object is required, basis frames are produced by applying the frame skip to the inputted images from the starting time to the ending time of the moving object (S510) The basis frames frame_{i,s+j*2-1} are a frame set used in reproducing a final image and are extracted from the images acquired by the n cameras from the starting time s along with the lapse of time j. Here, i (1≦i≦n) is a camera, acquired by a camera, from which a frame is extracted and j (1≦j≦k/2) is a lapse of time. The set of basis frames is expressed by the following equation.

$${F}_{active} = \{ \begin{matrix}{frame}_{1 , s + 1} , {frame}_{2 , s + 3} , {frame}_{3 , s + 5} , … , {frame}_{i , s + j * 2 - 1} , … , \\ {frame}_{n - 1 , k - 3} , {frame}_{n , k - 1}\end{matrix} \}$$

Frame pairs at the same time from the starting time to the ending time are combined and the frame skip is applied to the input images, then the interpolation reference frames are produced (S515). The interpolation basis frames are separately used in the image interpolation. The interpolation reference frame set F_{active}_{_{—}}ᵢₙₜₑᵣₚ is expressed by the following equation.

$${F}_{active\_interp} = \{ \begin{matrix}{frame}_{1 , s + 2} , {frame}_{2 , s + 2} , {frame}_{3 , s + 4} , {frame}_{4 , s + 4} , … , \\ {frame}_{n - 1 , k - 2} , {frame}_{n , k - 2}\end{matrix} \}$$

In this embodiment, adjacent frames are selected by skipping by every two frames within an F_{active} set. The interpolation reference frame set F_{active}_{_{—}}ᵢₙₜₑᵣₚ also constitute a frame set with the same number of frames in which every two frames form pairs used as basis frames for the interpolation. When every two frames are combined into pairs in the F_{active}_{_{—}}ᵢₙₜₑᵣₚ, different images mean still images at the same time point because time points from which the frames are extracted are the same. Thus, since there is no distortion due to the movements, the fundamental matrices can be extracted.

Next, the extracted images rectified based on the interpolation reference frames (S520) and the interpolation images between the adjacent frames are produced (S425). The interpolation images IFfame_{i,s+j,i+1,s+j} are produced by rectifying the extracted images using the extracted fundamental matrices and by applying a morphing-based method thereto. In this case, hardware acceleration based on a high speed image processing device such as GPU may support the production of the interpolation images in real time. Finally, arranged images F_{final} are expressed by the following equation.

$${F}_{final} = \{ \begin{matrix}{frame}_{1 , s + 1} , {Iframe}_{1 , s + 2 , 2 , s + 2} , {frame}_{2 , s + 3} , … , {frame}_{n - 1 , k - 3} , \\ {Iframe}_{n - 1 , k - 2 , k - 2} , {frame}_{n , k - 1}\end{matrix} \}$$

After that, the frames processed at the input reproducing speed are selected and outputted (S230).

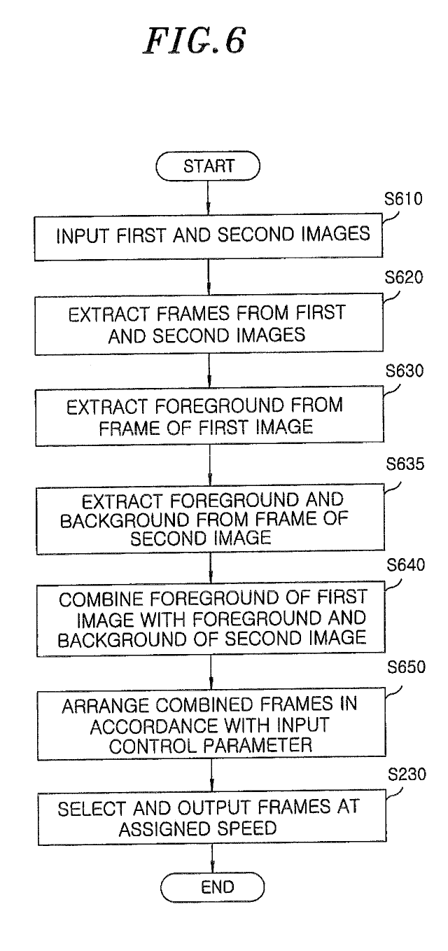

FIG. 6 is a flowchart illustrating a method of implementing a dual camera effect.

Dual motion control camera effect is a function of combining multiple images captured at different places to produce a new image. For example, a foreground (pitcher) and a background (baseball field) are separated from each other in a first image capturing a scene that a pitcher throws a ball and only the separated foreground (pitcher) is combined into a second image capturing a scene that a batter bats the ball thrown by the pitcher. Due to the combination, a dual motion control camera effect for the foreground (pitcher) of the first image and the foreground (batter) of the second image can be implemented in the background (baseball field) of the second image.

First, a first image of an object captured at a first point of view and a second image of the object captured at a second point of view are inputted (S610). The images may be inputted in such a way that an image from which only a foreground is extracted and an image from which a foreground and both of a background is extracted are distinguished, or two images are inputted and the image from which only a foreground is extracted and the image from which both of a foreground and a background is extracted are determined by a user's choice later. In this case, the two images may be displayed on a screen to allow the user to input his/her choice.

Frames of a target time are extracted from the first and the second image (S620). A foreground is extracted from the first image (S630) and a foreground and a background are extracted from the second image (S635) and the foreground extracted from the first image is combined with the foreground and the background extracted from the second image (S640). In the combination, an image processing may be further performed to compare and calibrate brightness, color, and light sources between the foreground of the first image and the foreground and the background of the second image.

Frames combined as described above are arranged in accordance with the control parameter (S650) and are selectively outputted in accordance with the inputted reproducing speed (S230). In this case, the foreground of the first image and the foreground of the second image may be independently controlled and reproduced at display speeds.

In another embodiment, an object may be a still object or a moving object. The above-mentioned still object motion control camera effect or the moving object motion control camera effect may be applied to the still object.

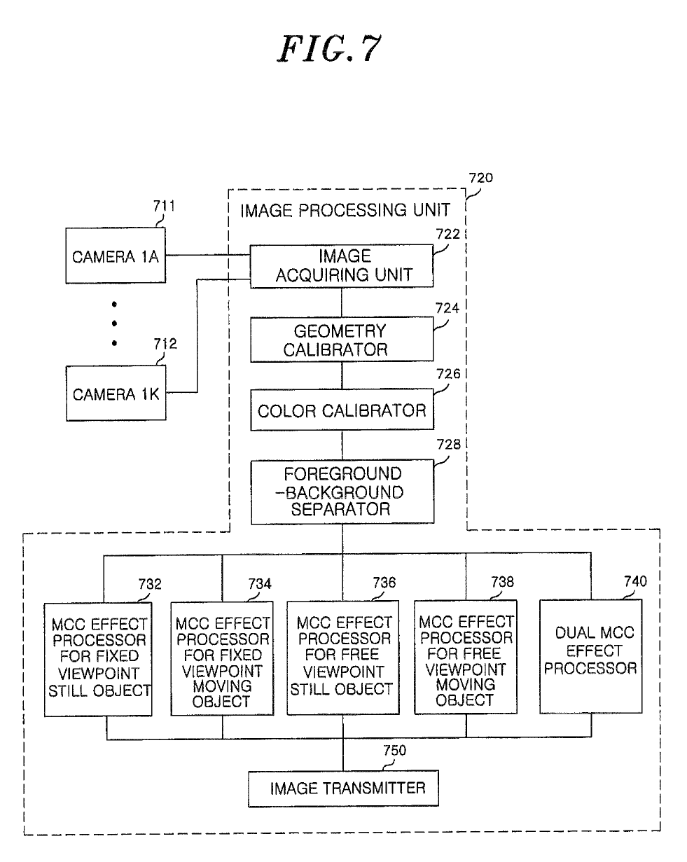

FIG. 7 is a schematic block diagram illustrating an apparatus for implementing a motion control camera effect in accordance with an embodiment of the present invention.

In this embodiment, an apparatus for implementing a motion control camera effect includes a plurality of cameras 711 and 712 and an image processing unit 720.

The image processing unit 720 includes an image acquiring unit 722 for acquiring an image transmitted from cameras 711 and 712, a geometry calibrator 724 for analyzing position information of the cameras from the acquired images, a color calibrator 726 for calibrating color of the acquired images, a foreground-background separator 728 for separating a foreground and a background from the acquired images or the calibrated images, and an image transmitter 750 for outputting the processed images.

Moreover, the image processing unit 720 may further include at least one of a fixed viewpoint still object motion control camera effect processor 732, a fixed viewpoint moving object motion control camera effect processor 734, a free viewpoint still object still object motion control camera effect processor 736, a free viewpoint moving object motion control camera effect processor 738, and a dual motion control camera effect processor 740. The various motion control camera effect processors 732, 734, 736, 738, and 740 may include devices for performing all steps of methods corresponding to the respective motion control camera effects.

Modules, functional blocks, and/or devices adopted in the above-mentioned embodiments may be implemented by one or a combination of at least two of various well-known devices such as an electronic circuit, an integrated circuit, an application specific integrated circuit (ASIC), and the like.

While the invention has been shown and described with respect to the embodiments, it will be understood by those skilled in the art that various changes and modifications may be made without departing from the scope of the invention as defined in the following claims.

What is claimed is:

1. A method of implementing a motion control camera effect comprising:
inputting images of an object captured at one or more points of view;
inputting a control parameter containing a motion control camera effect to be applied to the input images, a target time of the motion control camera effect, and a reproducing speed;
extracting frames of the target time from the input images;
processing the frames using software based on the control parameter; and
outputting the processed frames at the reproducing speed.

2. The method of claim 1, wherein the motion control camera effect includes at least one of a motion control camera effect for a fixed viewpoint still object, a motion control camera effect for a fixed viewpoint moving object, a motion control camera effect for a free viewpoint still object, a motion control camera effect for a free viewpoint moving object, and a dual motion control camera effect, in accordance with whether a point of view is fixed or free and the object is stopped or moving.

3. The method of claim 2, wherein, in a case of the motion control camera effect for the fixed viewpoint still object, in the processing the frames using the software based on the control parameter, the extracted frames are arranged in accordance with the control parameter.

4. The method of claim 2, wherein, in a case where of the motion control camera effect for the fixed viewpoint moving object, the target time has a starting time and an ending time of a movement of the object; and
wherein, in the processing the frames using the software based on the control parameter, the extracted frames are arranged in accordance with the control parameter.

5. The method of claim 2, wherein, in a case of the motion control camera effect for the free viewpoint still object, the processing the frames using software based on the control parameter, includes:
extracting corresponding points between adjacent frames;
calculating camera geometric information based on the corresponding points; and
producing an interpolation image between the adjacent frames.

6. The method of claim 5, wherein, in the calculating camera geometric information, fundamental matrices are obtained based on the corresponding points; and
wherein, in the producing the interpolation image between the adjacent frames, the extracted images are rectified using the fundamental matrices and the interpolation image is produced by applying a morphing-based method to the rectified images.

7. The method of claim 2, wherein, in a case of the motion control camera effect for the free viewpoint moving object, the extracting the frames of the target time from the input images includes:
producing basis frames by applying frame skip to the input images from the starting time to the ending time of the movement of the object; and
combining the frames into pairs at the same time from the starting time to the ending time into the input images and applying frame skip to produce an interpolation reference frame,
wherein, in the processing the frames using the software based on the control parameter, the extracted images are rectified based on the interpolation reference frame and interpolation image between the adjacent frames.

8. The method of claim 7, wherein, in the processing the frames using the software based on the control parameter, the interpolation image is produced using the interpolation reference frame and a frame set of the interpolation reference frame.

9. The method of claim 7, wherein, in the producing the interpolation image between the adjacent frames, the extracted images are rectified using the frame pairs at the same time and a morphing-based method is applied to the rectified images to produce the interpolation images.

10. The method of claim 9, wherein the producing the interpolation image by applying the morphing-based method to the rectified images is processed using a high speed image processing device based on hardware acceleration in real time.

11. The method of claim 2, wherein, in a case of the dual motion control camera effect, the input of the images of the object captured at said one or more points of view includes:
inputting two images of the object captured at different points of view; and
determining a first image from which a foreground is extracted and a second image from which a foreground and a background are extracted from the two images of the object;
wherein the extracting the frames at the target time from the input images is performed to the first image and the second image at the same time; and
wherein the processing the frames using the software based on the control parameter includes:
extracting the foreground from a frame of the first image;
extracting the foreground and the background from the second image;
combining the foreground of the first image with the foreground and the background of the second image to combine frames of the first image with frames of the second images; and
arranging the combined frames in accordance with the control parameter.

12. The method of claim 11, wherein, in the determination the first image from which the foreground is extracted and the second image from which the foreground and the background are extracted from the two images of the object, the determining is made by an input from a user.

13. The method of claim 11, wherein, in the combining the foreground of the first image with the foreground and the background of the second image, brightness, color, and a light source of the foreground of the first image are compared with those of the foreground and the background of the second image to be calibrated.

14. The method of claim 11, wherein, in the combining the foreground of the first image with the foreground and the background of the second image, moving speeds of the foreground of the first image and the foreground of the second image are independently controlled by making frame arranging speeds of the foreground of the first image and the foreground of the second image different from each other.

15. The method of claim 1, wherein the control parameter includes a reproducing direction.

16. An apparatus for implementing a motion control camera effect, comprising:
an image acquiring unit for receiving images of an object captured at one or more points of view;
a motion control camera effect input unit for receiving a motion control camera effect to be applied;
a control parameter input unit for receiving a control parameter including a target time and a reproducing speed of the motion control camera effect; and
a motion control camera effect processing unit for performing at least one of processing a motion control camera effect for a still object and a moving object at a fixed viewpoint and a free viewpoint and a dual motion control camera effect of receiving at least one image and combining a foreground of at least one image with a foreground and a background of another image.

17. The apparatus of claim 16, wherein the motion control camera effect processing unit includes:
at least one of fixed viewpoint still object motion control camera effect processors for implementing the motion control camera effect for the still object at the fixed viewpoint, a fixed viewpoint moving object motion control camera effect processor for implementing the motion control camera effect for the moving object at the fixed viewpoint, a free viewpoint still object motion control camera effect processor for implementing the motion control camera effect for the still object at the free viewpoint, a free viewpoint moving object motion control camera effect processor for implementing the motion control camera effect for the moving object at the free viewpoint, and a dual motion control camera effect processor for receiving at least one input image and combining the received images such that a foreground of one of the input images is combined with a foreground and a background of another received image;
a frame extractor for extracting frames at the target time from the input images;
a frame processor for processing the frames based on the control parameter; and
a frame output unit for selecting and outputting the processed frames in accordance with the reproducing speed.

18. The apparatus of claim 17, wherein the frame processor of the free viewpoint still object motion control camera effect processor includes:
a corresponding point extractor for extracting a corresponding point between adjacent frames;
a camera geometric information calculator for calculating camera geometric information based on the corresponding point; and
an interpolation image producer for producing an interpolation image between the adjacent frames.

19. The apparatus of claim 18, wherein the camera geometric information estimator comprises a fundamental matrix calculator obtaining a fundamental matrix based on the corresponding point; and
wherein the interpolation image producer has:
a rectifier for rectifying the input images using the fundamental matrix; and
a morphing unit for producing the interpolation image.

20. The apparatus of claim 17, wherein the frame extractor of the free viewpoint moving object motion control camera effect processor includes:
a basis frame producer for producing a basis frame by applying frame skip to the input image from a starting time to an ending time of the moving object of the input image;
an interpolation reference frame producer for producing interpolation reference frames by combining frames at the same time into frame pairs and by applying the frame skip to the input image from the starting time to the ending time;
an interpolation reference frame-based rectifier for rectifying the input image based on the interpolation reference frame; and
an interpolation image producer for producing an interpolation image between the adjacent frames.

21. The apparatus of claim 20, wherein the frame processor of the free viewpoint moving object motion control camera effect processor produces the interpolation image by using the basis frame and a frame set of the interpolation reference frames.

22. The apparatus of claim 20, wherein the interpolation image producer includes:
a frame pair using rectifier for rectifying the input images by using the frame pairs at the same time; and
a morphing unit for producing the interpolation image by applying a morphing-based method to the rectified images.

23. The apparatus of claim 20, further comprising a high speed image processing device for supporting a real time processing of the morphing unit through hardware acceleration.

24. The apparatus of claim 17, wherein the image acquiring unit receives two images of the object captured at one or more points of view and comprises an image determining unit for determining a first image from which a foreground is extracted and a second image from which a foreground and a background are extracted from the two images, based on an input from a user;
the frame extractor of the dual motion control camera effect processor performs the extractions from the first and second images simultaneously; and
the frame processor of the dual motion control camera effect processor includes:
a first image foreground extractor extracting the foreground from a frame of the first image;
a second image foreground-background extractor extracting the foreground and the background from a frame of the second image;
a foreground-background combining unit combining the foreground of the first image with the foreground and the background of the second image; and
a frame arranger arranging the combined frames in accordance with the control parameter.
